(19) United States
(12) Patent Application Publication
(10) Pub. No.: US 2008/0044244 A1
(43) Pub. Date: Feb. 21, 2008

(54) VETERINARY PRECISION FIXATION DEVICE AND METHOD OF USING THE SAME

(76) Inventor: Gary L. Keffer, Stilwell, KS (US)

Correspondence Address: BLACKWELL SANDERS LLP, 4801 Main Street, Suite 1000, KANSAS CITY, MO, 64112, US

(21) Appl. No.: 11/464,722

(22) Filed: Aug. 15, 2006

(51) Int. Cl. B23B 49/00

(52) U.S. Cl. 408/116

(57) ABSTRACT

A veterinary precision fixation device for use in tibial plateau leveling osteotomy procedures includes a jig assembly having a center jig member having a first and second end, a first jig leg pivotally coupled to the first end, and a second jig leg pivotally coupled to the second end. The device also includes a saw guide assembly having a saw fixation member slidably coupled to at least one slide bar wherein the slide bar is coupled to the center jig member proximate the first end. A method for using the precision fixation device in a tibial plateau leveling osteotomy is also provided.

### BACKGROUND OF THE INVENTION

The most common condition causing either acute or chronic hind leg lameness in dogs is injury to the anterior cruciate ligament, and subsequent instability in the knee joint. This results in severe cartilage erosion and degenerative joint disease. This arthritic condition is progressive, and without surgery leads to permanent weight-bearing lameness. Once a cruciate ligament injury or tear occurs, the anatomic stability of the joint is permanently changed.

The canine or feline stifle (knee) joint shares basic similarity to the human knee joint. The lower end of the femur rests on two doughnut-shaped cartilages (menisci) that sit on top of the tibia (tibial plateau). Two internal ligaments, the anterior and posterior cruciate ligaments, work to reduce shearing forces. The knee cap (patella) attaches to the tibia by the patellar ligament and acts to extend the stifle. The medial and lateral collateral ligaments stabilize the stifle joint side-to-side. Other internal ligaments stabilize the meniscal pads during flexing and extension.

In both the canine and feline patient, the femur rest on a tibial plateau that slopes to the back of the stifle. This slope varies by the animal's breed, size, and by individual and can vary from 5 to 40 degrees. This posterior slope results in a constant backward or posterior sliding motion (thrust) of the lower femur on the menisci and tibial plateau. This posterior thrust by the femur is countered by the anterior cruciate ligament (ACL) inside the stifle joint. It is common for the ACL to partially or completely tear as a result of normal shearing forces within the joint brought on by aging, wear and tear, and athletic activity. The, incidence of injury is far more common than in humans, and the surgical repair is complex. Abnormal shearing forces tear the meniscal cartilages and ulcerate the femoral condyles and truchlear groove, as the patella moves upward with normal extension of the leg.

A bone-cutting procedure that decreases the weight-bearing slope of the tibia to nearly 5° has been described by Barclay Slocum in U.S. Pat. No. 4,677,973 entitled “Proximal, tibial osteotomy for leveling a tibial plateau.” The procedure described therein hinges on accurately assessing the individual patient's joint pathology, surgically changing the slope without changing other forces within the joint, and assessing, and then correcting, any meniscal damage. The surgical procedure, as disclosed by the '973 patent and its progeny, encompasses a specific surgical approach to the stifle joint and proximal tibia and then the attachment of a jig to the tibia. This is accomplished primarily by visualizing certain landmarks and making a freehand, curved, but ideally perpendicular, cut through the tibial plateau with a vibrating oscillating saw. The procedure described in the '973 patent is open to severe error because the surgeon must simultaneously visually hold the saw in three dimensions as it cuts freehand through the tibia.

Accordingly, there is a need in the art for a device that helps to control the freehand cut made by the oscillating curved saw blade. There is also a need in the art for a jig that is less subjectively applied to the tibia thereby reducing human error in placement.

### SUMMARY OF THE INVENTION

This invention relates generally to a veterinary surgical device and a method of using a veterinary surgical device. In particular, the present invention relates to a precision fixation device for use in tibial plateau leveling osteotomies that reduces surgical error, assists in providing a concise bone cut, and results in minimal bone and soft tissue destruction during surgery. The veterinary precision fixation device of the present invention generally includes a jig assembly having a center jig member having a first and second end, a first jig leg pivotally coupled to the first end, and a second jig leg pivotally coupled to the second end. The device also includes a saw guide assembly having a saw fixation member slidably coupled to at least one slide bar wherein the slide bar is coupled to the center jig member proximate the first end.

### BRIEF DESCRIPTION OF THE SEVERAL VIEWS OF THE DRAWING

In the accompanying drawings that form a part of the specification and that are to be read in conjunction therewith and in which like reference numerals are used to indicate like parts in the various views:

FIG. 1 is a top perspective view of the precision fixation device in accordance with one embodiment of the present invention;

FIG. 2 is a top perspective exploded view of the precision fixation device in accordance with one embodiment of the present invention;

FIG. 3 is a top perspective view of the precision fixation device shown in conjunction with an oscillating saw and an animal's tibia in phantom in accordance with one embodiment of the present invention;

FIG. 4A is a top perspective view of the second slide bar and second adjustment member in accordance with one embodiment of the present invention;

FIG. 4B is a top perspective view of the first slide bar in accordance with one embodiment of the present invention;

FIG. 5 is a top perspective view of the center jig member 16 in accordance with one embodiment of the present invention;

FIG. 6 is a top perspective view of the saw guide member in accordance with one embodiment of the present invention;

FIG. 7A is a top perspective view of one of the jig legs in accordance with one embodiment of the present invention;

FIG. 7B is a top plan view of the jig leg of FIG. 7A in accordance with one embodiment of the present invention; and

FIG. 8 is a bottom perspective view of an adjustment member in accordance with one embodiment of the present invention.

### DETAILED DESCRIPTION OF THE INVENTION

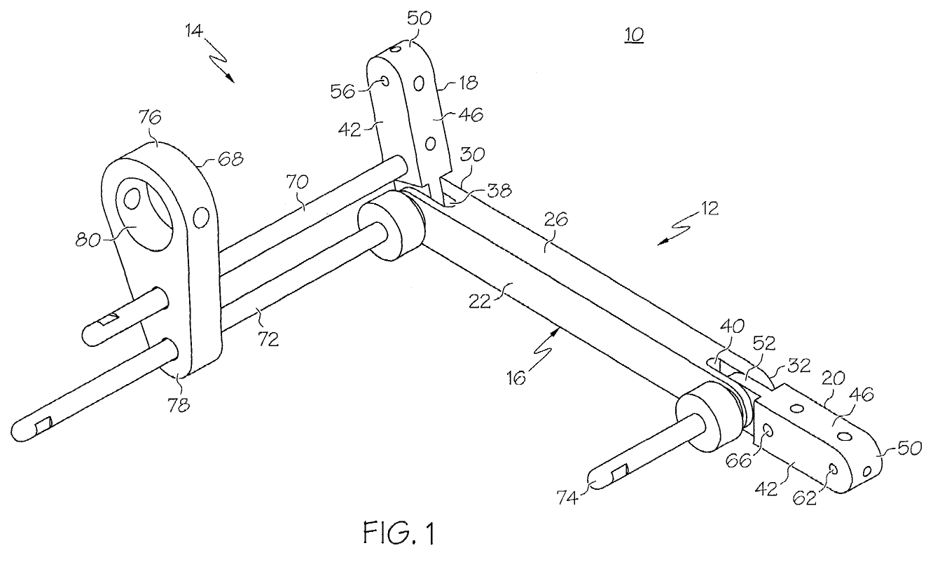

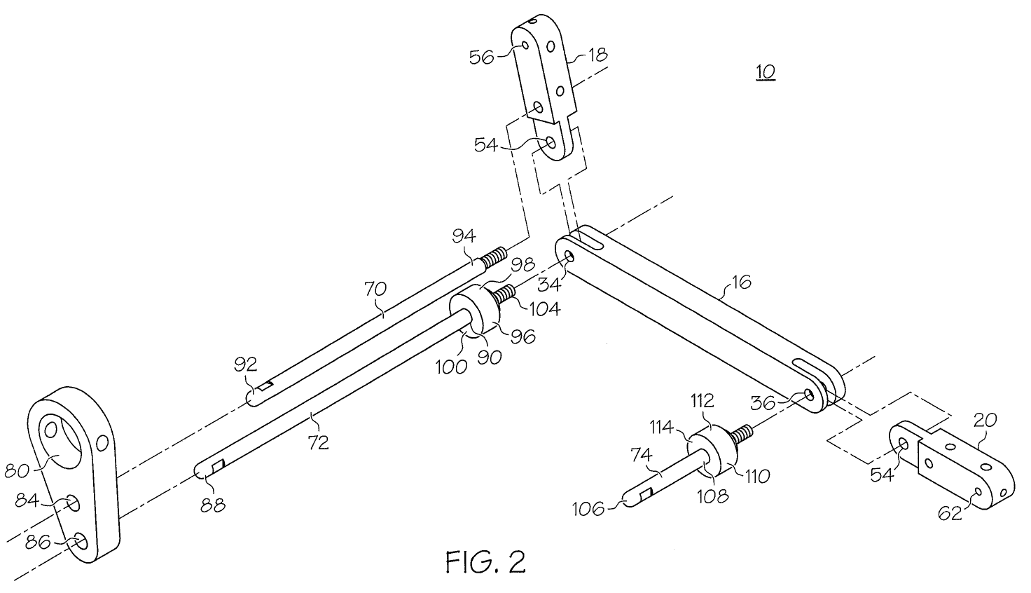

As shown in FIGS. 1-3, the precision fixation device 10 of the present invention includes a jig assembly 12 and a saw guide assembly 14. Jig assembly is preferably formed from stainless steel, plastic, or any other material suitable for use in veterinary surgery. Jig assembly 12 includes a center jig member 16, a first jig leg 18, and a second jig leg 20. Center jig member 16, as shown in FIG. 5, is preferably from about 3.0-6.0 in length (L), from about 0.5-0.7 wide (W), and from about 0.3-0.6 inches high (H). However, it will be appreciated by one skilled in the art that the dimensions of center jib member may be altered to suit the size of the animal being operated upon or to meet any other desired application. Center jig member 16 includes a generally planar or flat top surface 22, an opposing generally planar bottom surface 24, a generally planar inner surface 26, an opposing generally planar outer surface 28, a generally rounded first end 30, and an opposing generally rounded second end 32. Each of first and second ends 30 and 32 includes a first and second aperture 34 and 36, respectively, extending through center jig member 16 from top surface 22 to bottom surface 24. First and second apertures 34 and 36 preferably have a diameter of from about 0.15-0.2 inches and are configured to receive a screw 104 or 118 of a first or second adjustment member 96 or 110 described hereinbelow. In one embodiment, apertures 34 and 36 may have a threaded interior surface configured for receiving a screw or other threaded coupling mechanism therethrough. However, it is within the scope of this invention that the interior surface of apertures 34 and 36 may be smooth or otherwise configured to receive any suitable coupling mechanism. Each of first and second ends 30 and 32 also include first and second cutout portions 38 and 40, respectively, each having a height of from about 0.16 to 0.2 inches and extend inwardly from each of ends 30 and 32 about 0.3-0.7 inches toward the center of center jig member 16. Cutout portions 38 and 40 are configured to receive a first end 50 of each of first and second jig legs 18 and 20 and are preferably disposed about 0.18-0.24 inches below top surface 22 and about 0.9-0.14 inches above bottom surface 24. First and second apertures 34 and 36 are preferably spaced from about 0.2-0.4 inches from first and second ends 30 and 32, respectively, with a distance between first and second apertures 34 and 36 of from about 2.0-6.0 inches such that apertures 34 and 36 are interrupted by cutout portions 38 and 40.

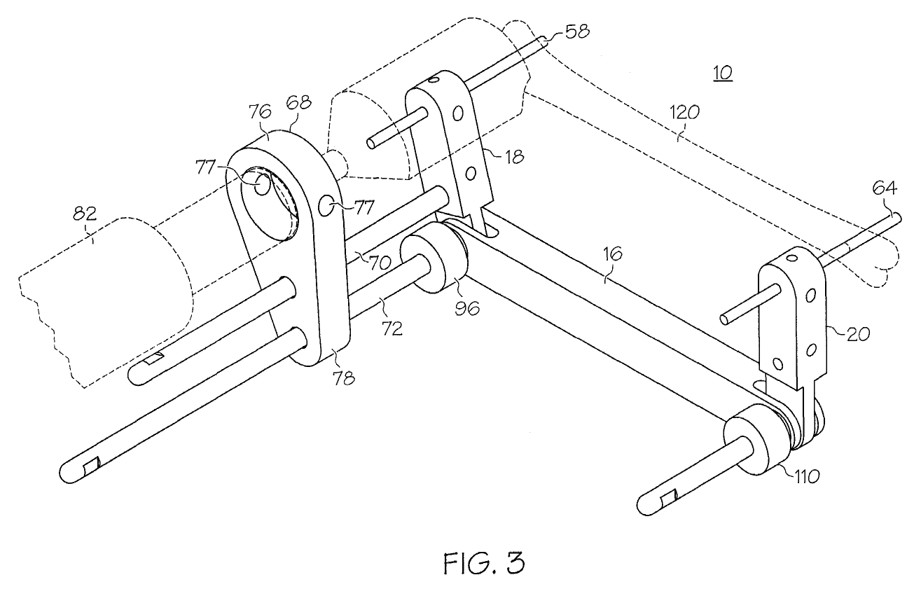

First and second jig legs 18 and 20, shown in FIGS. 7A and 7B, are each preferably from about 1.0-4.0 inches long (L), from about 0.3-0.7 inches wide (W), and include a generally planar top surface 42, an opposed generally planer bottom surface 44, a generally planar inner surface 46, an opposed generally planar outer surface 48, a generally rounded first end 50 and a generally rounded second end 52. The height (H) of jig legs 18 and 20 at first end 50 is preferably from about 0.3-0.7 inches and tapers or reduces approximately hallway along length L to a height (H) of from about 0.16 to 0.2 inches at second end 52. It will be appreciated that second end 52 is configured to be inserted into cutout portions 38 and 40. Jig legs 18 and 20 each include an adjustment member aperture 54 extending from top surface 42 to bottom surface 44 and proximate second end such that, when second end 52 is inserted into a cutout portion 38, 40, adjustment member aperture 54 lines up with first and second apertures 34 and 36 in center jig member 16 such that adjustment member 96 or 110 described hereinbelow may be inserted through center jig member 16 and second end 52 thereby enabling adjustable pivotal movement of jig leg 18 or 20 between anywhere between a 30-300 degree radius from center jig member 16. An upper tibial positioning aperture 56 extending through first end 50 of first jig leg 18 from top surface 42 to bottom surface 44 is configured to receive an upper tibial pilot pin 58 therethrough as shown in FIG. 3. A first slide bar aperture 60 extending generally through the center of first jig leg 18 from top surface 42 to bottom surface 44 is configured to threadably receive a first slide bar 70 therein or therethrough. In one embodiment, slide bar aperture 60 may have a threaded interior surface configured for receiving a screw or other threaded coupling mechanism therein. However, it is within the scope of this invention that the interior surface of slide bar aperture 60 may be smooth or otherwise configured to receive any suitable coupling mechanism for coupling with first slide bar 70. A lower tibial positioning aperture 62 extending through first end 50 of second jig leg 20 from top surface 42 to bottom surface 44 is configured to receive a lower tibial pilot pin 64 therethrough as shown in FIG. 3. Second jig leg 20 may be identical to first jig leg 18 for interchangeably and may also include a slide bar aperture 66 extending generally through the center of second jig leg 20 from top surface 42 to bottom surface 44 that is configured to receive a slide bar (not shown) therein or therethrough.

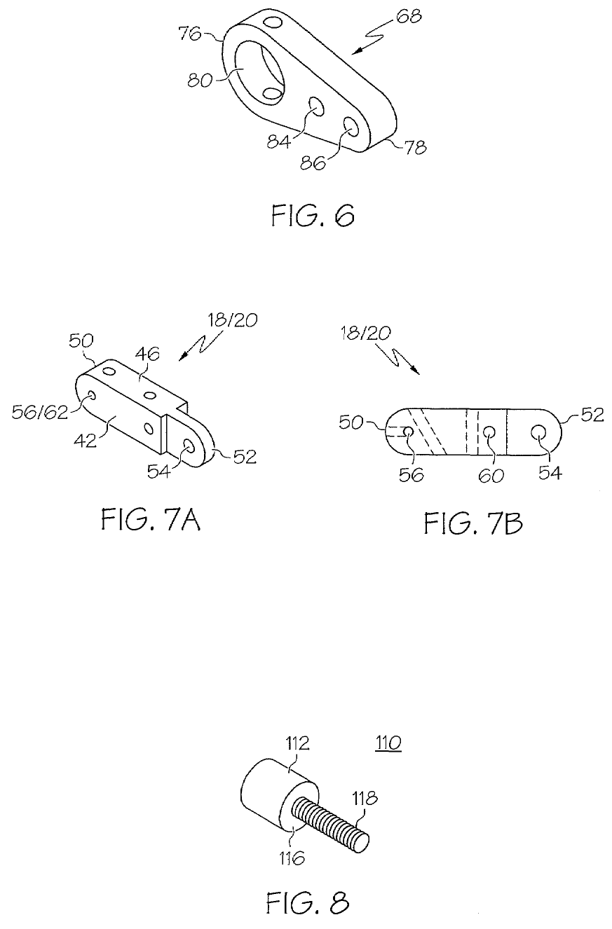

Saw guide assembly 14 includes saw fixation member 68, a first slide bar 70, a second slide bar 72, and an adjustment bar 74. Saw guide assembly 14 is preferably formed from stainless steel, plastic, or any other material suitable for use in veterinary surgery. Saw fixation member 68 may be any shape having rounded edges for safety purposes. In one embodiment as shown in FIG. 6, saw fixation member 68 has a roughly triangular shape with rounded edges such that a first end 76 has a larger width than a second end 78. For example, first end 76 is preferably from about 1.2 to 1.9 inches wide at its widest point whereas second end 78 is preferably from about 0.4-1.0 inches wide at its widest point. First end 76 includes a saw positioning aperture 80 extending therethrough configured for receiving and supporting a vibrating oscillating saw 82 therein and therethrough as shown in phantom in FIG. 3. First end 76 also includes opposing set screw apertures 77 for receiving set screws (not shown) for tightening and securing saw 82 within saw positioning aperture 80. Second end 78 includes a second slide bar aperture 84 extending therethrough configured for receiving second slide bar 72 therethrough. Between saw positioning aperture 80 and second slide bar aperture 84, saw fixation member 68 also includes a first slide bar aperture 86 extending therethrough configured for receiving first slide bar 70 therethrough.

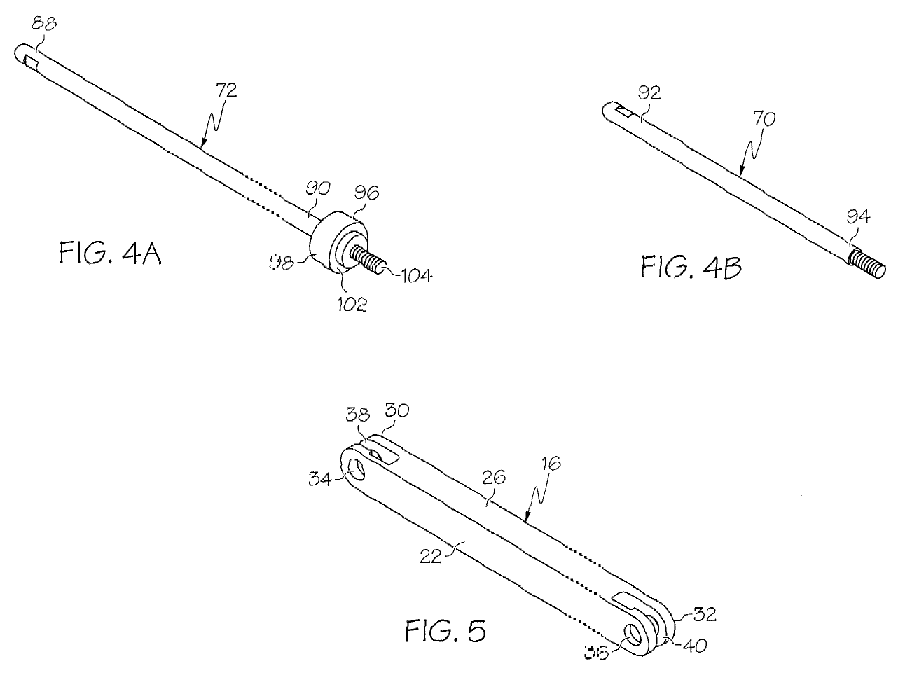

Second slide bar 72 as shown in FIG. 4B is generally cylindrical having a rounded first end 88 and a threaded second end 90 for threadably engaging first slide bar aperture 60 in first jig leg 18. First slide bar 70 is generally cylindrical and preferably has a smaller or shorter length than that of second slide bar 72. First slide bar 70 as shown in FIG. 4A includes a rounded first end 92 and a second end 94 having a first adjustment member 96 threadably coupled thereon or otherwise permanently affixed thereto. Adjustment member 96 includes a generally O-shaped shoulder 98 having a top surface 100 and a bottom surface 102 defining an optional aperture (not shown) therethrough. Aperture may include a threaded interior for threadably coupling with second end 94 of first slide bar 70. In another embodiment, second end 94 of first slide bar 70 may be welded, soldered, or simply glued to top surface 100 or within aperture. Bottom surface 102 of adjustment member includes a screw 104 extending outwardly therefrom and configured to threadably couple with first slide bar aperture 60 on first end of center jig member 16. In the preferred embodiment, screw 104 has a length sufficient to extend through first aperture 34 adjacent top surface 22 of center jig member 16, through adjustment member aperture 54 of first jig leg 18 when second end 52 of first jig leg 18 is inserted into cutout portion 38 proximate first end 30 of center jig member 16, and then through first aperture 34 adjacent bottom surface 24 of center jig member 16.

Adjustment bar 74 is generally cylindrical and may have a shorter length than that of either first or second slide bars 70 and 72. Adjustment bar 74 includes a generally rounded first end 106 and an opposing second end 108 having a second adjustment member 110, one embodiment of which is shown in FIG. 8, threadably coupled thereon or otherwise permanently affixed thereto. Adjustment member 110 includes a generally O-shaped shoulder 112 having a top surface 114 and a bottom surface 116 defining an optional aperture (not shown) therethrough. Aperture may include a threaded interior for threadably coupling with second end 108 of adjustment bar 74. In another embodiment, second end 108 of adjustment bar 74 may be welded, soldered, or simply glued to top surface 114 or within aperture. Bottom surface 116 of adjustment member 110 includes a screw 118 extending outwardly therefrom and configured to threadably couple with second aperture 36 proximate second end 32 of center jig member 16. In the preferred embodiment, screw 118 has a length sufficient to extend through second aperture 36 adjacent top surface 22 of center jig member 16, through adjustment member aperture 54 of second jig leg 20 when second end 52 of second jig leg 20 is inserted into cutout portion 40 proximate second end 32 of center jig member 16, and then through second aperture 36 adjacent bottom surface 24 of center jig member 16.

In use, an animal patient is maintained on isofluorane anesthesia with constant anesthetic monitoring in dorsal recumbency and with complete body drape and the surgery leg free in a vertical plane. Routine pre-operative betadyne preparation is performed prior to draping. The patient's leg is extended and flexed to evaluate pre-operative anatomy and to determine if any valgus or varus deviation or torsion of distal extremity exists. Pre-operative radiographs have identified a desired plateau slope change of from 5-40 degrees. The surgical blade chosen varies based on the anterior-posterior thickness of the tibia. The tibial plateau rotation is calculated based on the chosen blade, and the degree of rotation.

The skin and subcutaneous fascia are incised down to the periosteum, from the tibial plateau to approximately 2 cm distal to the tibial crest in an anteromedial plane approximately 1.5 cm caudal to the palpable anterior midline edge of the tibial crest and distally parallel with the tibial shaft. The skin and subcutaneous incision is extended proximally and caudally in a slightly curved fashion to the level of the proximal patella. The periosteum starting at the tibial plateau is incised distally to the limits of the skin-subcutaneous incision. The periosteum is then reflected anteriorly to the edge of the tibial crest, with a periosteal elevator, and also posteriorly beneath the muscle attachments of the pes ansorimus group to the posterior edge of tibia 120 by a combination of sharp scalpel dissection and periosteal elevation. This landmark dissection reveals the 1) medical aspect of the stifle joint, 2) the medial collateral ligament, and 3) the muscle fiber attachment of the popliteus to the caudal femur. From the tibial plateau, the periosteal incision is carried proximal, deeper through fascial planes to the sartorius muscle attachment. Care should be taken to not enter the femorotibial joint space. Three 25 gauge needles are used to identify the tibial plateau, and the caudal aspect of the tibia 120, just caudal to the medial collateral ligament.

A 5 mm incision is made immediately caudal to the posterior edge of the medial collateral ligament, through the joint capsule with a #15 blade. Through this 5 mm incision, a #11 blade is inserted, pointed anterolateral at an imaginary point halfway between the tibial crest and the fibular head, and used to cut the medial meniscus, releasing it to fall posteriorly. The 5 mm incision is closed with cruciate 2-0 PDS. Three 25 gauge needles are placed in the knee joint as close to the tibial plateau as possible, the first caudal to the patellar ligament, the second approximately 5-8 mm caudal to the meniscal release incision, and the third at the posterior but most proximal point on tibia 120.

The popliteus muscle fibers, as attached to posterior tibia 120, are cut close to tibia 120, from approximately 2 cm distal to the caudal edge of the femorotibial joint (as previously found with a 25 gauge needle) for approximately 4 cm. Using a sharp periosteal elevator, all muscle fibers and soft tissue are separated from the posterior-lateral aspect of the femur. The pocket created is packed with 3-4 saline-soaked gauze sponges. The tibialis anterior muscle is separated from its tibial plateau attachment from 2 cm below the femoral tibial joint and distally 3-4 cm by using sharp periosteal elevator dissection. The pocket created is packed with saline-soaked gauze sponges.

The patient's leg should be positioned accurately to pinpoint accurate placement of the upper and lower tibial positioning pins 58 and 64 that hold jig assembly 12 in place. The stifle and hock joints are flexed with the femur perpendicular thereto. That is, the femur is vertical to the table and the patient's foot/metatarsus is held or positioned against the surgeon's chest. Tibia 120 is held substantially parallel to the surgical table and substantially perpendicular to the femur. If a valgus or varus tibial deviation is present, the foot/metatarsus will not appear vertical or parallel with the femur.

In another embodiment of the method of the present invention, the patient is positioned in lateral recumbency and the surgery leg placed on the table, in a substantially perfect horizontal plane with stifle and tibiotarsal joints partially flexed. After the patient is placed in lateral recumbency, a vacuum positioner bag is placed beneath the surgical leg. A horizontal laser beam is used to position the distal leg, from just above the patella, so that the horizontal beam of the laser lays center of the patellar ligament, center of the proximal to distal tibia, and to the center of the torsus. The vacuum positioner bag is deflated when the leg is parallel to the horizontal beam.

A ⅛″ threaded pin is inserted through a small stab wound approximately 5 mm distal to the second 25 gauge needle and midway between the posterior edge of the medial collateral ligament and the third 25 gauge needle. The pin is started to make a small pilot hole and then removed. Prior to drilling the proximal pin, the laser horizontal beam is used to confirm that the lower leg is in a substantially perfect horizontal plane. If the leg is positioned correctly, the laser beam bisects the patella, the patellar ligament, the tibia, and the metatarsus. In general, if the leg is positioned correctly prior to surgery on the vacuum positioner bag and, if the leg has not been repositioned, then no adjustments in positioning of the leg should be necessary.

Preplaced 25 gauge needles identify the posterior edge of the proximal tibia 120, and the posterior edge of the femorotibial joint. A 25 gauge needle is placed just caudal to the medial collateral ligament in the joint. A second 25 gauge needle is “walked” off the posterior-proximal edge of tibia 120. The tip of the proximal pin is placed 2-5 mm caudal to the medial collateral ligament, and 3-5 mm below the joint. In general the pin will be placed caudal of the medial collateral ligament, ⅔ of the distance between the medial collateral ligament and the posterior edge of tibia 120.

The proximal pin is verified to be substantially vertical to the plane of tibia 120 with the vertical laser beam and then it is seated through tibia 120. The laser insures accuracy of the pin placement, that is, the pin is desirably substantially perpendicular to the horizontal plane of the tibia.

Precision fixation device 10 is substantially preassembled for a left or right leg surgery by an assistant. Assembled device 10 is slid over upper tibial positioning pin 58 via upper tibial positioning aperture 56. The lower tibial positioning pin 64 is positioned in the distal one-third of tibia 120 via lower tibial positioning aperture 62. A 5 mm skin incision makes a window for pin 64 to enter the bone of tibia 120. The laser is now used to verify that device 10 is in a substantially perfect horizontal plane and parallel to the plane of the tibia 120. Device 10 is generally held tight against the proximal tibia 120 and the lower 64 pin is then set. The laser again is used to verify the absolute vertical position of the lower tibial pin 64 as it is seated through tibia 120.

The appropriate cutting blade is generally chosen prior to surgery. Any diameter blade may be used in connection with device 10. Saw fixation member 68 is slid onto the first and second slide bars 70 and 72, the blade of saw 82 is positioned on tibia 120 so that the proximal edge of the saw 82 will cut the proximal end tibia 120. Set screws are tightened within screw apertures 77 to prevent saw 82 from rotating within saw fixation member 68. At 90# of pressure, saw 82 is capable of guiding itself through the bone of tibia 120 thereby insuring a substantially perfect 90° cut in all planes relative to tibia 120.

Saw 82 should not move out of the precision plane when it is fixed in position by the saw fixation member 68 on slide bars 70 and 72. Saw 82 is then activated and, with aggressive flushing, tibia 120 is cut approximately two-thirds of the way through. The saw blade is then retracted and chisel marks are made to accurately delineate the mm of rotation. The saw cut is completed with rigorous irrigation by inserting saw 82 into the previous saw cut and activating saw 82. The saw blade is not rotated or twisted by the surgeon, but instead allowed to slowly cut by the actual blade vibration on tibia 120.

Once tibia 120 is cut, jig assembly 12 is checked to confirm that it is secure. The saline soaked gauze is removed from the lateral aspect of tibia 1420. A threaded ⅛″ pin is drilled medial to lateral, obliquely, through the proximal cut fragment, close to the saw line. A second pin is then used to rotate the proximal cut segment so that the rotation is complete and the chisel lines meet. A 1/16″ threaded pin is inserted just lateral to the patellar ligament attachment to the tibial crest and is driven posterior into the proximal cut fragment.

Prior to plating, the cut line is visualized for plate placement. The appropriate TPLO plate is contoured to fit the cut surface and proximal shaft of tibia 120. Care is taken to get a perfect anatomical fit. The distal 3 holes are drilled, tapped, and screws placed in a neutral position. Holes 4 & 5 are drilled and 4.0 mm cancellous screws are placed in a loading position, but are tightened together. Hole 6 is drilled parallel to the tibial plateau, and a 4.0 mm cancellous screw is tightened.

A culture is taken prior to closure. O-PDS is used to close the periosteum and pes ansorinus group over the plate with simple interrupted sutures. The fascia and subcutaneous are closed with 2-0 PDS sutures. If possible, a subeuticular pattern is run with 2-0 vicryl. Stainless steel staples close the skin. A light pressure wrap over the incision and down tibia 120 to the hock joint is applied. Post-op x-rays are taken to evaluate the bone cut line, closure of the saw line, and final degrees of rotation.

From the foregoing, it may be seen that the inventive precision fixation device and method of using the same is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

I claim:

1. A veterinary precision fixation device comprising:
a jig assembly having a center jig member having a first and second end, a first jig leg pivotally coupled to said first end, and a second jig leg pivotally coupled to said second end; and
a saw guide assembly having a saw fixation member slidably coupled to at least one slide bar wherein said slide bar is coupled to said center jig member proximate said first end.

2. The device of claim 1, said slide bar further comprising an adjustment member for selectively tightening said slide bar to said center jig member.

3. The device of claim 2, said adjustment member being configured for selectively tightening said first jig leg to said first end.

4. The device of claim 3, further comprising an adjustment member coupled to said center jig member proximate said second end for selectively tightening said second jig leg to said second end.

5. The device of claim 1 wherein said first and second jig legs each have a shorter length than said center jig member.

6. The device of claim 1 wherein said first jig leg further comprises an upper tibial positioning aperture configured for receiving an upper tibial positioning pin.

7. The device of claim 1 wherein said second jig leg further comprises a lower tibial positioning aperture configured for receiving a lower tibial positioning pin.

8. The device of claim 1 wherein said saw fixation member defines a saw positioning aperture configured to receive an oscillating saw therein.

9. The device of claim 1 wherein said device is formed of a material selected from the group consisting of stainless steel, plastic, and combinations thereof.

10. A method for performing a tibial plateau leveling osteotomy comprising the steps of:
providing a veterinary precision fixation device including a saw guide assembly and a jig assembly having a center jig member having a first and second end, a first jig leg having an upper tibial positioning aperture extending therethrough wherein said first jig leg is pivotally coupled to said first end, and a second jig leg having a lower tibial positioning aperture extending therethrough wherein said second jig leg is pivotally coupled to said second end;
creating a first pilot hole proximate an animal patient's upper tibia;
inserting an upper tibial positioning pin through said upper tibial positioning aperture and into said first pilot hole;
creating a second pilot hole proximate an animal patient's lower tibia;
inserting a lower positioning pin through said lower tibial positioning aperture and into said second pilot hole; and
coupling an oscillating saw with said saw guide assembly.

11. The method of claim 10, said saw guide assembly further comprising a saw fixation member slidably coupled to at least one slide bar wherein said slide bar is coupled to said center jig member said first end.

12. The method of claim 11, said slide bar further comprising an adjustment member for selectively tightening said slide bar to said center jig member.

13. The method of claim 12 further comprising the step of tightening said slide bar said center jig member.

14. The method of claim 13, said adjustment member also being configured for selectively tightening said first jig leg to said first end.

15. The method of claim 14 further comprising the steps of positioning and tightening said first jig leg to said first end.

16. The method of claim 10, said jig assembly further comprising an adjustment member coupled to said center jig member proximate said second end for selectively tightening said second jig leg to said second end.

17. The method of claim 16 further comprising the step of positioning and tightening said second jig leg to said second end.

18. The method of claim 11 wherein said saw fixation member defines a saw positioning aperture configured to receive said oscillating saw therein.

19. A saw guide assembly comprising:
a saw fixation member having at least one slide bar aperture and a saw fixation aperture extending therethrough;
at least one slide bar slidably coupled with and extending through said slide bar aperture; and
an oscillating saw inserted through said saw fixation aperture.
